(19) United States
(12) Patent Application Publication
(10) Pub. No.: US 2006/0237499 A1
(43) Pub. Date: Oct. 26, 2006

(54) Cup holder

(75) Inventor: Johann Teichrieb, Loehne (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Electronics & Components GmbH & Co. KG

(21) Appl. No.: 11/401,581

(22) Filed: Apr. 11, 2006

(30) Foreign Application Priority Data
Apr. 15, 2005 (DE) 20 2005 006 077.1

(51) Int. Cl. B60R 7/00; B60R 11/00

(52) U.S. Cl. 224/281; 224/275; 224/554; 224/567; 224/570; 224/926

(57) ABSTRACT

A cup holder, in particular for a motor vehicle, includes a base plate (14), a support (16) onto which the base plate (14) is attached such that it is adjustable between an initial position and a holding position for a cup (12). Further, a holding part (24) is provided, which is connected to the base plate (14) such that, when the base plate (14) is brought from the initial position to the holding position, it is brought from an initial position to a holding position in which it reliably holds the cup (10) securely in the cup holder (12).

### TECHNICAL FIELD

The invention relates to a cup holder, in particular for a vehicle.

### BACKGROUND OF THE INVENTION

A cup holder must fulfil a number of requirements. On the one hand it must be visually pleasing, and on the other hand be able to reliably hold and secure cups with different diameters. Of course, the term “cup” also applies here to bottles or cans, i.e. any type of container in which drinks can be held. The cups here can be made from different materials such as glass or plastic, they can have different surface structures, so for example, they can have a smooth surface, and of course have different diameters. Cup holders must be able to hold all of these cups securely, and even prevent the cup from falling over when the vehicle brakes. Furthermore, the cup holder must be able to adapt to different cup diameters without great complexity, and so be easy to use. Known cup holders often can not adapt quickly and reliably to different cup diameters.

The invention therefore provides a cup holder which adapts to different cup diameters and holds the cup securely.

### BRIEF SUMMARY OF THE INVENTION

According to the invention, a cup holder, in particular for a motor vehicle, comprises a base plate, a support onto which the base plate is attached such that it is adjustable between an initial position and a holding position for a cup. Further, a holding part is provided, which is connected to the base plate such that, when the base plate is brought from the initial position to the holding position, it is brought from an initial position to a holding position in which it reliably holds the cup securely in the cup holder. Therefore only the base plate needs to be moved, so that the holding part moves with it. In this way the cup can be reliably secured in the cup holder, and automatic securing and clamping of the cup is guaranteed. Furthermore, the base plate can be moved from the initial position down into the holding position by means of a movement about a horizontal axis. No unusual or additional manipulation is required, therefore, in order to move the base plate into the holding position in which the cup holder can securely hold the cup. This makes it easy to use the cup holder.

Preferably, the base plate can be pivoted about a horizontal axis. The base plate is therefore pressed down into the holding position. This movement is the normal movement when setting down a cup, and no unusual or additional manipulation is required in order to move the base plate into the holding position in which the cup holder can securely hold the cup.

Preferably, a snap mechanism is provided which urges the base plate either into the initial position or the holding position. This snap mechanism makes it possible to precisely define each position. Because the base plate has a stable position, even in the holding position, a positioned cup is not pushed upwards, even when it is almost empty and is very light.

Preferably, the snap mechanism has a pressure spring, the line of action of which changes from one side of the pivot axis of the base plate to the other when the transition is made from the initial position to the holding position. The pressure spring makes it possible for there to be two stable positions of the base plate and a compact design.

A brake is preferably provided which locks the holding part in the holding position. The brake, which holds the holding part securely, makes it possible to hold the cup securely even if the motor vehicle accelerates strongly.

The brake can be formed by an adjustable brake shoe, which is attached to the support, and a brake surface, which is allocated to the holding part. Because the brake directly engages the holding part, there is a direct load transmission. Furthermore, the design is compact.

An actuation lever is provided, e.g., which is connected to the base plate and presses the brake shoe against the brake surface when the base plate is in the holding position. This makes it possible for the base plate and the holding part to be adjusted first, for the cup to be securely clamped, and then for the brake to be applied. In this way, the cup holder can even remain in the holding position when the cup is removed so as to reposition the cup after removal.

The brake shoe and/or the brake surface are preferably provided with toothing. The holding power is increased by the toothing.

In accordance with a first embodiment, the holding part is translatorily movable from the initial position to the holding position. A pivot movement of the base plate can easily be converted into a translatory movement.

Preferably, the holding part is attached to a bearing plate which is attached movably to the support. In this way, with smaller cup diameters the bearing plate can be moved, and it is thus made possible to adapt to different cup diameters.

The holding part is preferably attached pivotably to the bearing plate and is urged by a spring into a rest position. The holding part can in this way adapt to different cup diameters.

Preferably, a lever gear is provided which converts the pivotal movement of the base plate into a translatory movement of the bearing plate when the transition is made from the initial position to the holding position. The lever gear acts here as the transmission and makes it possible for the holding part attached to the bearing plate to be moved, despite the limited structural space, so as to clamp the cup securely. In this way, the necessary adjustment of the bearing plate can be achieved, even with small cup diameters.

The lever gear preferably has an actuation lever which is connected to the base plate by means of a spring so that the actuation lever can remain behind the pivot movement of the base plate. This makes it possible for cups with different diameters to be securely held, independently of the position of the base plate.

The actuation lever is connected e.g. to a coupling lever which in turn is connected to a transmission lever which is attached pivotably to the support and engages the bearing plate for the holding part. The lever gear thus functions in a mechanically simply manner and requires little space.

The transmission lever has e.g. a pin which engages into a link in the bearing plate. The connection is also easy to produce mechanically.

Preferably, the brake surface is formed on the bearing plate. In this way, both simple and effective braking is guaranteed.

In accordance with one embodiment, the holding part is rotatably movable from the initial position into the holding position. By means of the rotatory movement of the holding part, cups with different diameters can be clamped. It is not necessary here to attach two rotatably adjustable holding parts. Just one holding part is sufficient.

The holding part is preferably mounted pivotably on the support. In this way it is possible to make adjustments dependent upon the support.

Preferably, two holding parts are provided opposite one another. The holding parts positioned opposite one another make possible greater variability with regard to different cup diameters.

A lever can be provided which is mounted pivotably on the support and is connected to the holding part by means of a spring so that the rotation of the holding part can remain behind the rotation of the lever. In this way, different cup diameters can be compensated as the spring becomes more or less tensioned.

The holding part is preferably provided with the brake surface. The brake thus directly engages the holding part, and is therefore very effective.

The base plate has e.g. an actuation surface which engages the lever in such a way that the latter is adjusted outwards when the base plate is pivoted out of the initial position into the holding position. Here, the actuation surface of the base plate directly engages the lever and so is effective without any intermediary elements so that the connection is simple to produce and easily set up.

Preferably, a housing is provided in which the support is movably attached with the base plate and the holding part. A spring is provided which urges the support into an extended position, and a push-push mechanism is provided which can both lock the support in a retracted position and release it. Because a housing is provided and the support is movably attached with the base plate and the holding part, the cup holder can be moved into a position where it is not visible to a vehicle passenger, and so can be guaranteed to be visually pleasing. A spring is provided so as to urge the cup holder into an extended position. The push-push mechanism can lock the support in a retracted position, and release it. The push-push mechanism is of a similar construction to a push-in ballpoint pen. The cup holder will only be urged by the spring into the extended position if pressure is applied to the section of the cup holder visible to the vehicle passenger. In order to restore it to the retracted position, the cup holder must be pushed back by applying continuous pressure to the section visible to the passenger, and it is securely locked in the retracted position by the push-push mechanism.

The spring is preferably a roller spring. A spring in the form of a roller spring is essentially more compact than a spiral tension spring. In this way, the required structural space of the cup holder can be reduced.

### BRIEF DESCRIPTION OF THE DRAWINGS

FIG. 1 shows a perspective view of a cup holder in accordance with the invention according to a first embodiment in an extended position,

FIG. 2 shows a view of the cup holder in the extended position,

FIG. 3 shows a perspective view of the cup holder in a holding position with a cup which has a small cup diameter,

FIG. 4 shows a perspective view of the cup holder in the holding position with a cup which has a large cup diameter,

FIG. 5 shows a view of the cup holder without a housing in the extended position,

FIG. 6 shows a sectional view of the cup holder along the line VI-VI in FIG. 5 with the cup holder in the extended position,

FIG. 7 shows a sectional view of the cup holder in accordance with FIG. 6 with the cup holder in the holding position,

FIG. 8 shows a partially sectional view of the cup holder in the extended position with a housing,

FIG. 9 shows a view of the cup holder with a cup which has a small cup diameter,

FIG. 10 shows a view of the cup holder with a cup which has a large cup diameter,

FIG. 11 shows a view of the cup holder with a cup which has a small cup diameter,

FIG. 12 shows a view of the cup holder with two cups, with one cup having a small cup diameter, and the second cup having a large cup diameter,

FIG. 13 shows a sectional view of the cup holder along the line XIII-XIII in FIG. 5 with the cup holder in the extended position,

FIG. 14 shows a sectional view of the cup holder in accordance with FIG. 13 with the cup holder in the holding position,

FIG. 15 shows a sectional view of the cup holder along the line XV-XV in FIG. 11 with the cup holder in the holding position,

FIG. 16 shows a perspective view of a cup holder in accordance with the invention according to a second embodiment in an extended position,

FIG. 17 shows a view of the cup holder in the extended position,

FIG. 18 shows a perspective view of the cup holder in a holding position with a cup which has a small cup diameter,

FIG. 19 shows a view of the cup holder in accordance with FIG. 18,

FIG. 20 shows a perspective view of the cup holder in the holding position with a cup which has a large cup diameter,

FIG. 21 shows a view of the cup holder in accordance with FIG. 20,

FIG. 22 shows a view of the cup holder without a housing with a cup which has a large cup diameter,

FIG. 23 shows a view of the cup holder in the holding position,

FIG. 24 shows a perspective view of the cup holder with a cup which has a large cup diameter,

FIG. 25 shows a sectional view of the cup holder along the line XXV-XXV in FIG. 23,

FIG. 26 shows a view of the cup holder without a housing in the extended position,

FIG. 27 shows a view of the cup holder in the extended position,

FIG. 28 shows a perspective view of the cup holder in the extended position,

FIG. 29 shows a sectional view of the cup holder along the line XXIX-XXIX in FIG. 27,

FIG. 30 shows a perspective view of a holding part of the cup holder,

FIG. 31 shows a view of the cup holder in the extended position with a brake,

FIG. 32 shows a sectional view of the cup holder along the line XXXII-XXXII in FIG. 31,

FIG. 33 shows a view of the cup holder in the holding position with the brake, and

FIG. 34 shows a sectional view of the cup holder along the line XXXIV-XXXIV in FIG. 33.

### BRIEF DESCRIPTION OF THE PREFERRED EMBODIMENTS

This invention shows a cup holder 10 which is attached, for example, to a centre console (not shown) of a vehicle and is not visible to a passenger in a retracted position. The cup holder 10 serves to hold a cup 12.

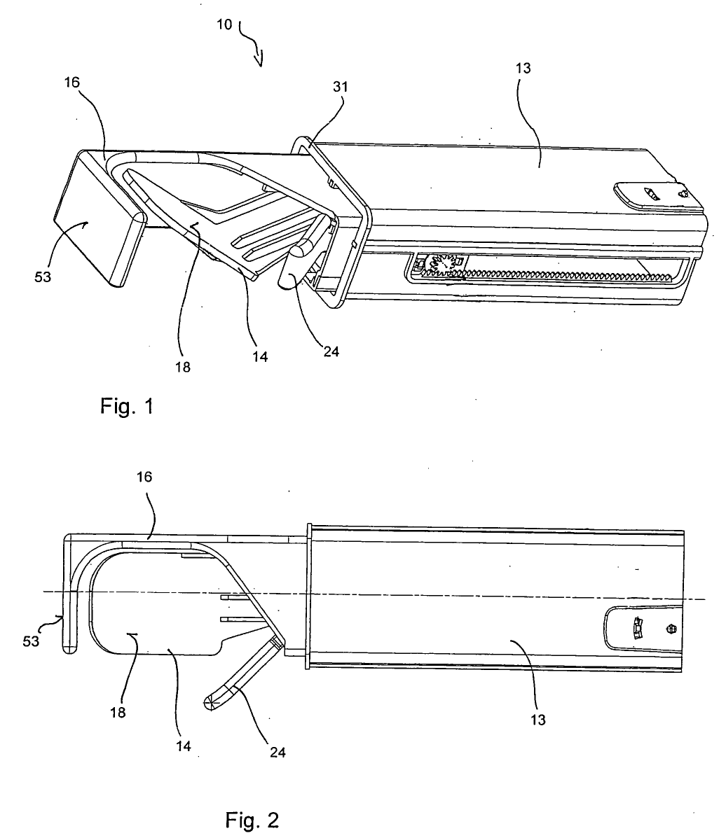

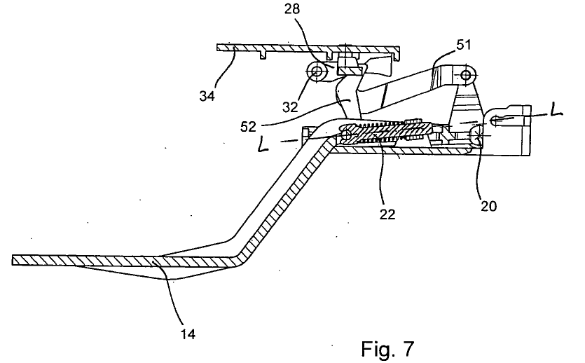

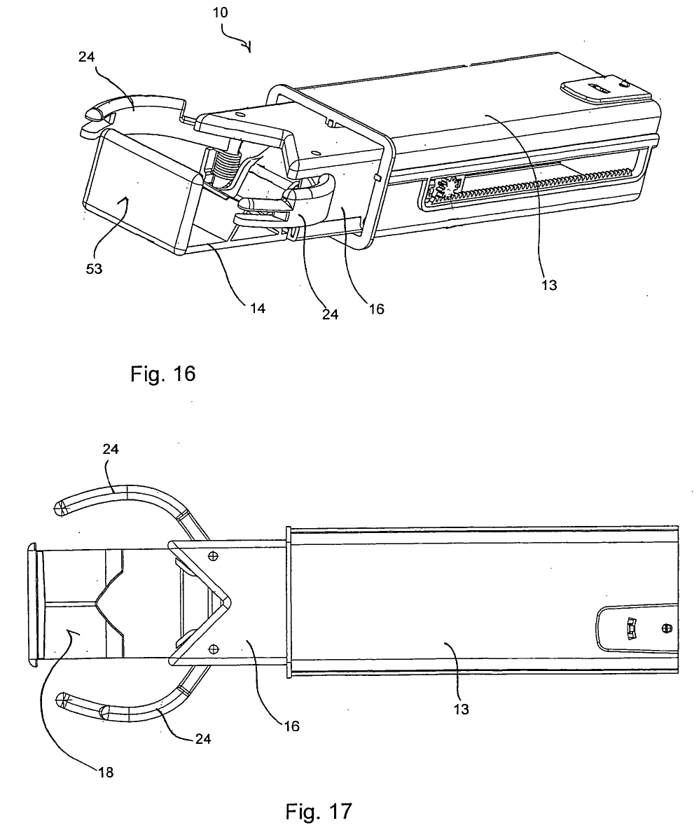

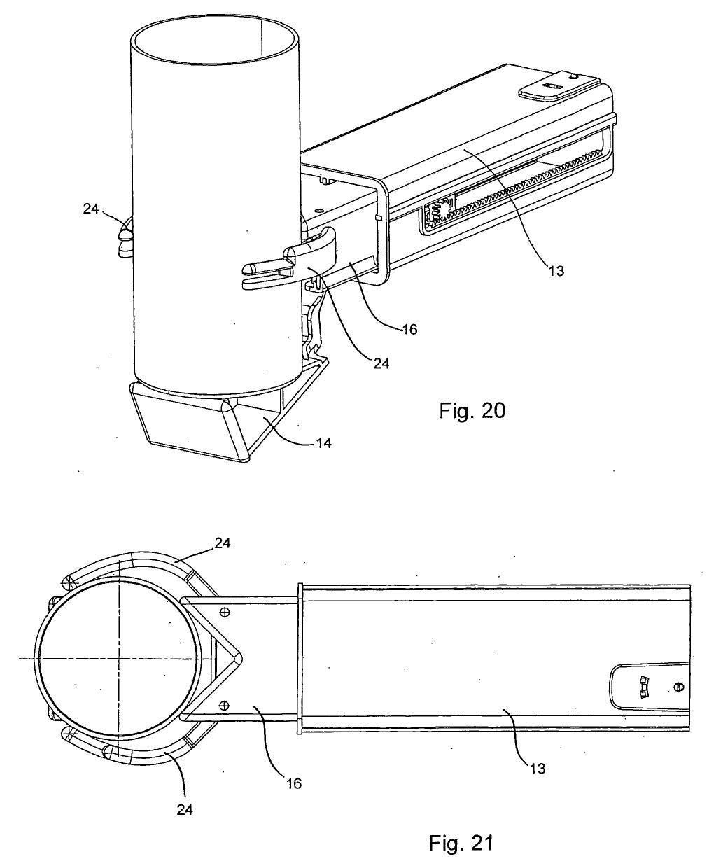

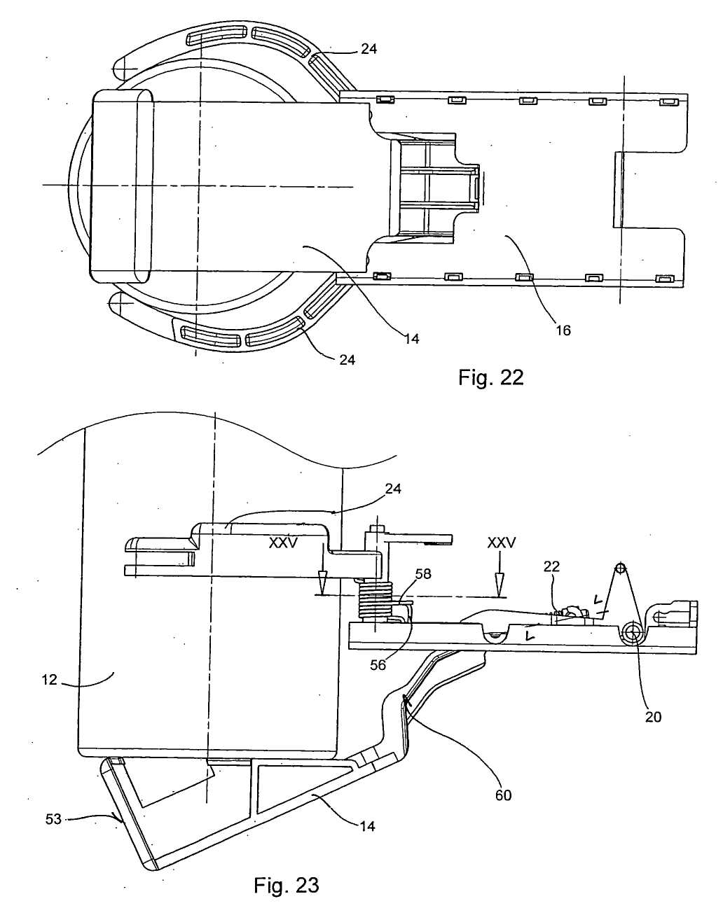

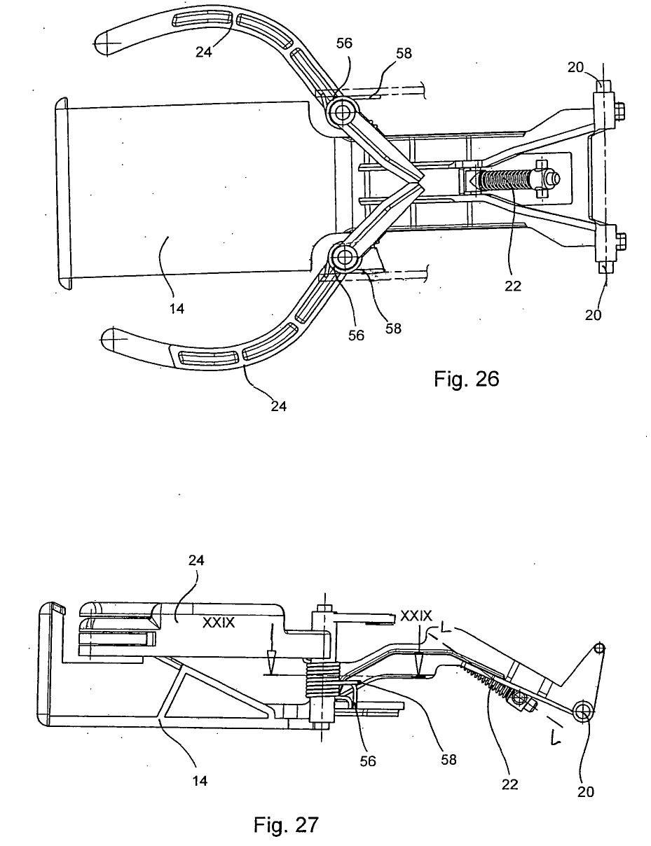

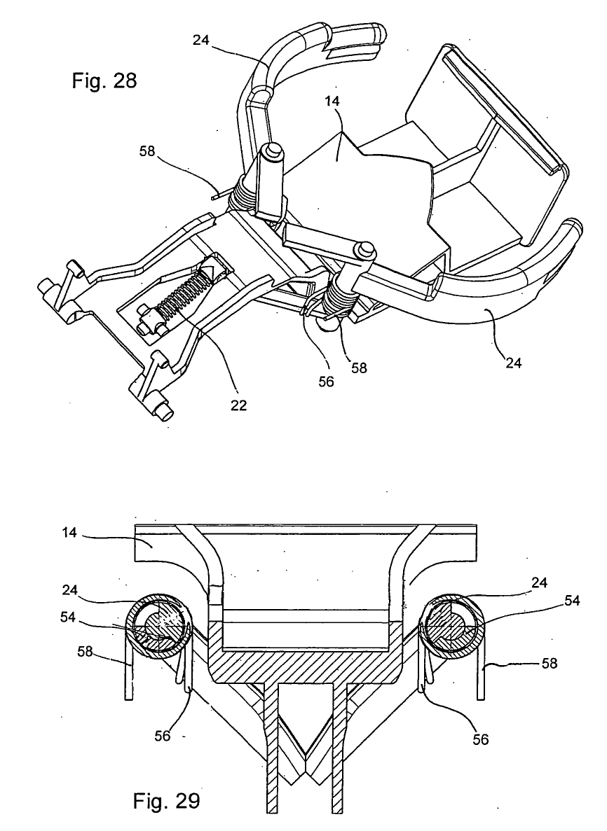

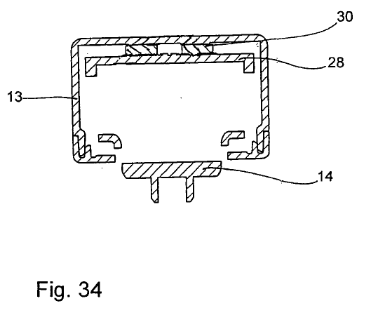

The cup holder 10 is shown in two embodiments, the first embodiment comprising FIGS. 1 to 15, and the second embodiment comprising FIGS. 16 to 34.

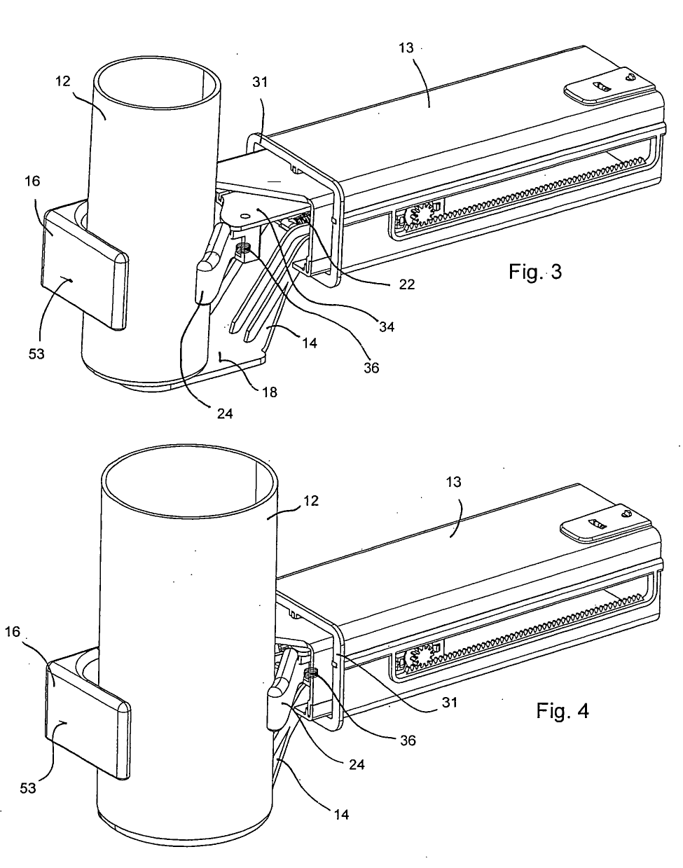

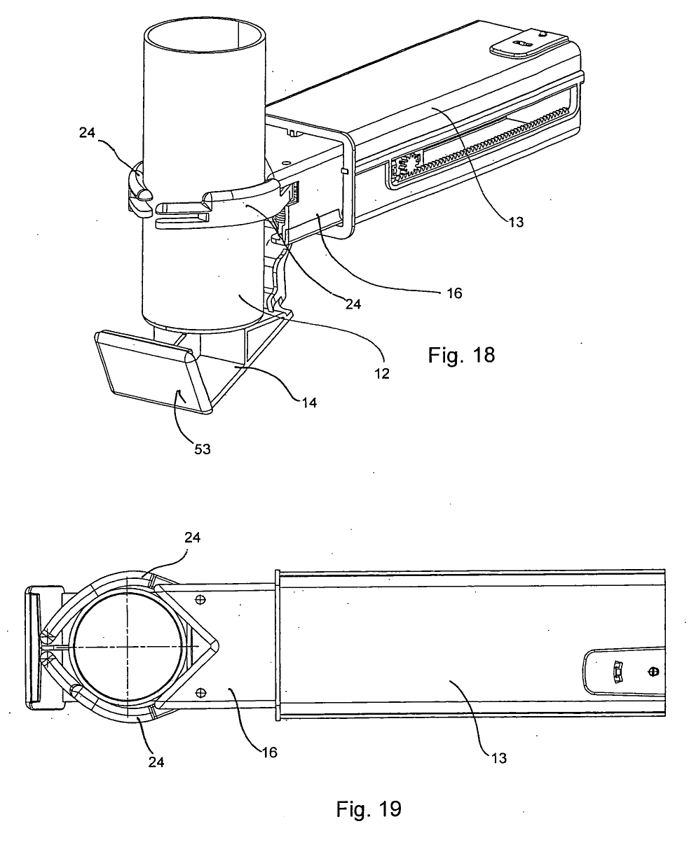

The cup holder 10 of both embodiments has a base plate 14 which is attached to a support 16. The base plate 14 can be adjusted between an initial position (FIGS. 1, 16) and a holding position (FIGS. 3, 18) for the cup 12.

The base plate 14 is made from a synthetic and is multi-angled in form. The angled form makes it possible for the base plate 14 in the retracted position to be pushed back into a housing 13 such that it is not visible to the vehicle passenger.

The base plate 14 has a support surface 18 upon which the cup 12 can rest. The support surface 18 is graduated in form. Furthermore, the support surface 18 can have a roughened surface (not shown) so as to guarantee a better grip for the cup 12.

In the area of the support surface 18, the base plate 14 takes almost the whole width of the cup holder 10 so as to provide a sufficiently large support surface for the cup 12.

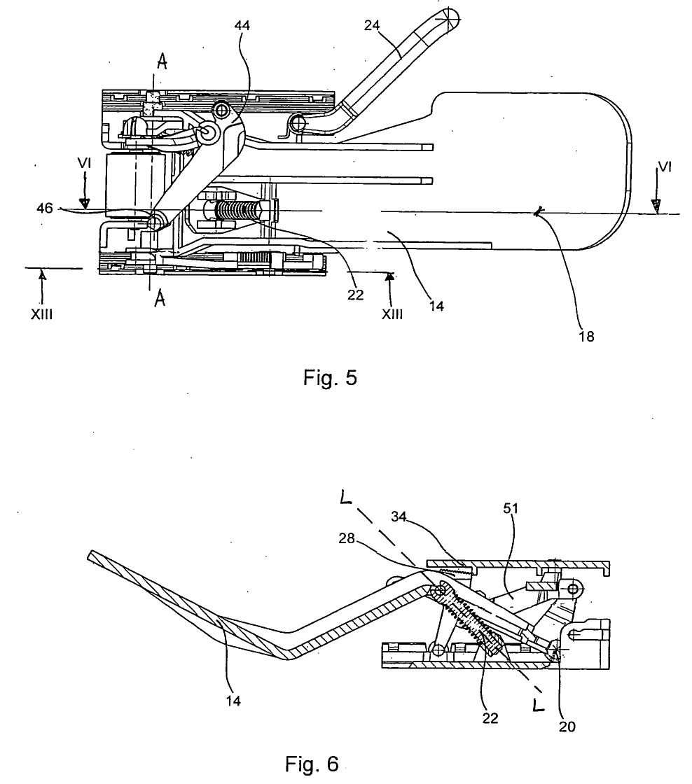

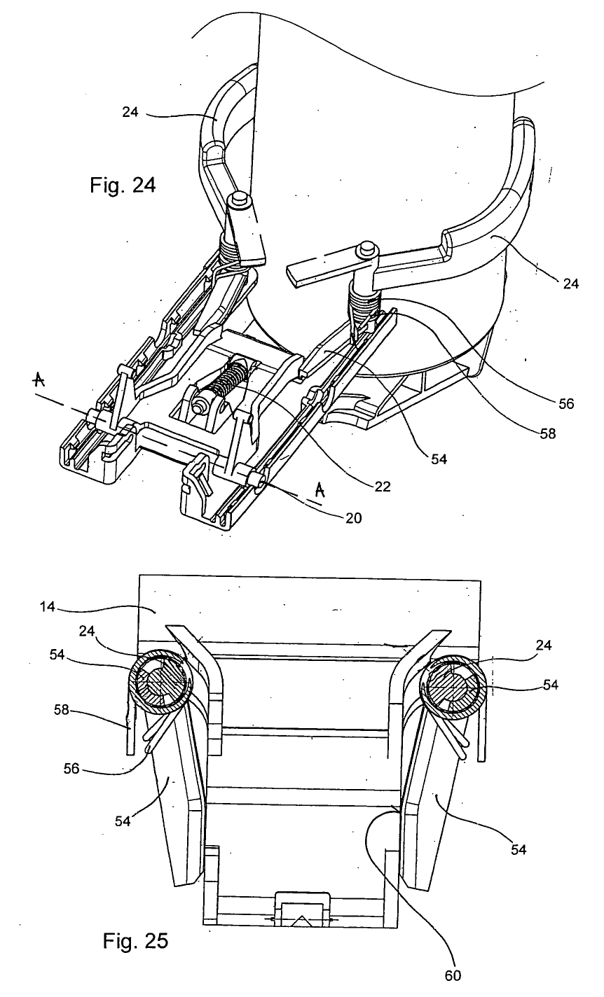

The base plate 14 is attached pivotably to the support 16 by means of an attachment means 20. The attachment means 20 here forms the horizontal rotation axis A (FIGS. 5, 24) of the base plate 14.

A pressure spring 22 is provided which is arranged on the support 16 and engages the base plate 14. The pressure spring 22 can urge the base plate 14 either into the initial or into the holding position.

The cup holder 10 has at least one holding part 24 made from a synthetic. The holding part 24 is connected to the base plate 14 and can engage the cup 12 and hold it securely.

The cup holder 10 has a brake 26. The brake 26 can lock the holding part 24 in the holding position. The brake 26 is formed by a brake shoe 28 and a brake surface 30. The brake shoe 28 here is adjustably attached to the support 16 by means of an attachment means 32, and extends over a part of the width of the housing 13. The brake surface 30 is allocated to the holding part 24. The brake shoe 28 and the brake surface 30 are provided with toothing so as to increase the holding force. An actuation lever 52 is provided by means of which the brake 26 can be actuated. The actuation lever 52 here is connected to the base plate 14 by means of another lever 51. The actuation lever 52 connected to the lever 51 can press the brake shoe 28 against the brake surface 30 when the base plate 14 is in the holding position.

The housing 13 can accommodate the support 16, the base plate 14 and the holding part 24. A cover 31 and a section 53 are provided which are visible to the vehicle passenger on the centre console (not shown) of the vehicle in the retracted position. Alternatively, a face plate can also be positioned at the front.

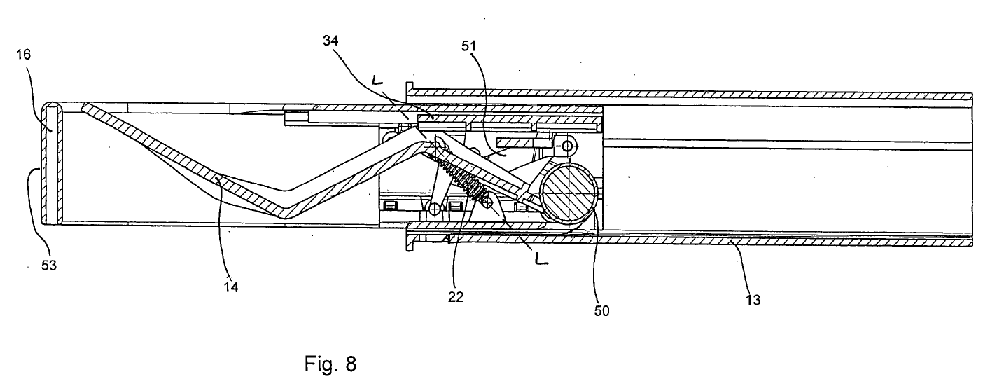

A push-push mechanism is provided which is known with cup holders. The push-push mechanism can lock the support 16 in the retracted position, and release it. A spring 50 (FIG. 8), which is in the form of a roller spring, is attached here to the housing 13, and can urge the cup holder 10 from the retracted position into an extended position.

The spring 50 is pre-tensioned by the movement of the cup holder 10 from the extended position to the retracted position.

In the following, reference will be made to the two embodiments. For the components which are already known, the same reference numbers will be used, and in this respect, one should refer to the above explanations.

FIGS. 1 to 15 show the cup holder 10 in a first embodiment.

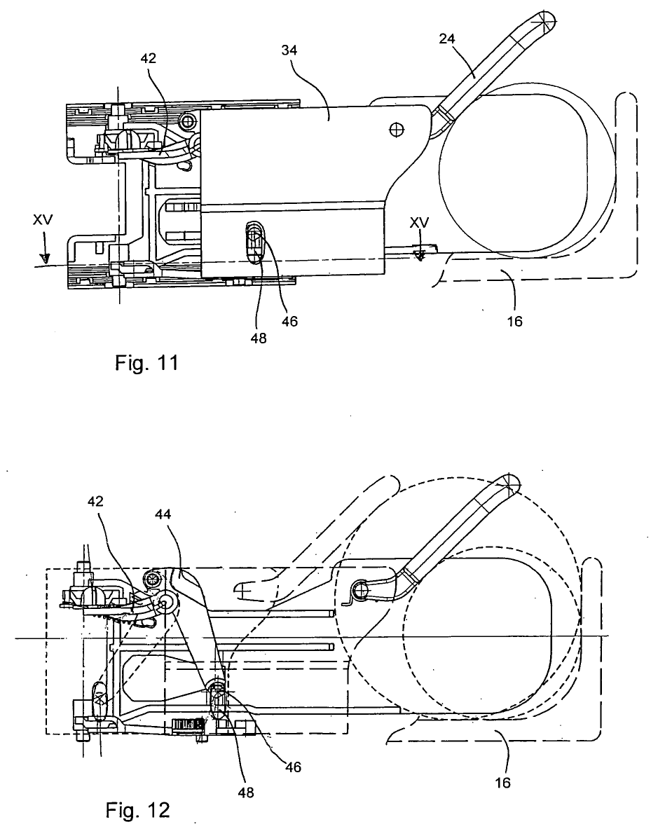

The holding part 24 is attached pivotably to a bearing plate 34 by means of a spring 36, and the bearing plate 34 in turn is attached movably to the support 16 (FIGS. 5, 11).

The holding part 24 extends partially parallel to the bearing plate 34, and is shown as angled outwards in the adjoining section, so that the holding part 24 can engage the cup 12 and partially encompass it.

The support 16 extends in an elongation parallel to the housing 13 and in an adjacent area, perpendicular to this elongation. In the area which is perpendicular to the housing 13, the support has the section 53 which is visible to the passenger in the retracted position.

The support 16 has a rounded surface facing the base plate 14 against which the cup 12 rests in the holding position.

The cup holder 10 has a lever gear (FIGS. 10 to 12) which consists of an actuation lever 38, a coupling lever 42 and a transmission lever 44.

The actuation lever 38 is connected to the base plate 14 by means of a spring 40, and attached to the support 16. The coupling lever 42 is connected on the one hand to the actuation lever 38, and on the other hand to the transmission lever 44. The transmission lever 44 is attached to the support 16 and engages the bearing plate 34. The transmission lever 44 here has a pin 46 which engages in a link 48 in the bearing plate 34.

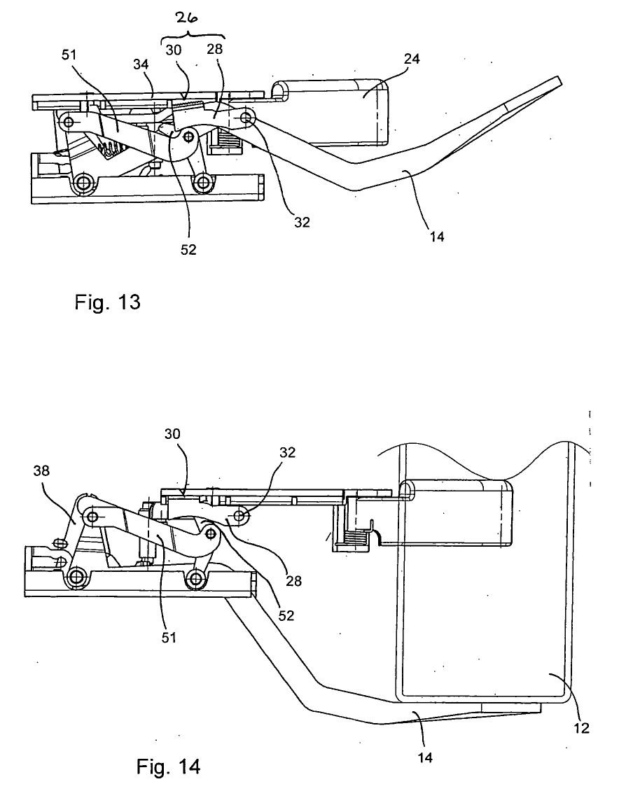

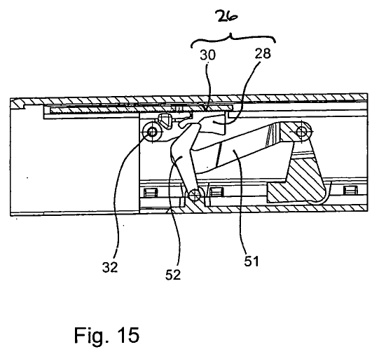

The cup holder 10 has the brake 26 already specified above. The brake shoe 28 is attached to the support 16 by an attachment means 32. The brake surface 30 is arranged on the bearing plate 34. Both the brake shoe 28 and the brake surface 30 are provided with toothing (FIGS. 13, 15).

In the following, the functionality of the cup holder 10 is described.

The cup holder 10 is urged by the spring 50 (FIG. 8) into the extended position following a push on the externally visible section 53 of the support 16. The holding part 24, which is subject to the pre-tensioning of the spring 36, is moved out of the housing 13 and urged outwards into a rest position. The base plate 14 is held in the initial position by the snap mechanism of the pressure spring 22.

In the initial position, the base plate 14 does not actuate the lever 51, and hence, it does not actuate the actuation lever 52 of the brake 26, so that the brake shoe 28 is not pressed against the brake surface 30.

When the base plate 14 is moved about the rotation axis A which is located on the attachment means 20, the line of action L of the pressure spring 22 changes from one side of the pivot axis A of the base plate 14 to the other when there is a transition of the base plate 14 from the initial position to the holding position. When this happens, the pressure spring 22 is first of all compressed until a dead centre is reached. Then the pressure spring 22 presses the base plate 14 down into the holding position. Due to the pressure spring 22 and the change of its line of action L, the base plate 14 is held firmly in the holding position.

A movement of the lever gear is also coupled with a movement of the base plate 14. The lever gear translates the movement of the base plate 14 into a translatory movement of the bearing plate 34 because the actuation lever 38 is connected to the base plate 14 and connected to the transmission lever 44 by means of the coupling lever 42. The pin 46 of the transmission lever 44 is moved here in the link 48 of the bearing plate 34. When the bearing plate 34 is moved, the holding part 24 moves towards the cup 12 and can encompass it so that the cup 12 is clamped between the holding part 24 and the rounded surface of the support 16.

Because the base plate 14 is connected by means of the lever 51 to the actuation lever 52, and the latter engages the brake shoe 28, the actuation lever 52 is pressed against the brake shoe 28 when the base plate 14 reaches the holding position. The brake shoe 28 is thus pressed against the brake surface 30 and the bearing plate 34 is locked (FIG. 14). The brake shoe 28 is pressed against the brake surface 30 when the base plate 14 is in the holding position. Even when the cup 12 is removed, the cup holder 10 remains in the holding position because the actuation lever 52 is perpendicular to the brake surface 30. The perpendicular position of the actuation lever 52 is the most stable position that it can be in. The actuation lever 52 and the associated brake 26 are only released again when the cup holder 10 is pushed in because when pushed in, the base plate 14 is pushed upwards into the initial position.

By continuously pushing the section 53 of the support 16, the cup holder 10 is moved into the retracted position. In the retracted position, the cup holder 10 is locked by the push-push mechanism. The spring 50 is pre-tensioned by pushing the cup holder 10 into the retracted position. In this way, the spring 36 connected to the holding part 24 is also pre-tensioned because the holding part 24 is pushed inwards by the housing 13 so as to reach the retracted position in the housing 13.

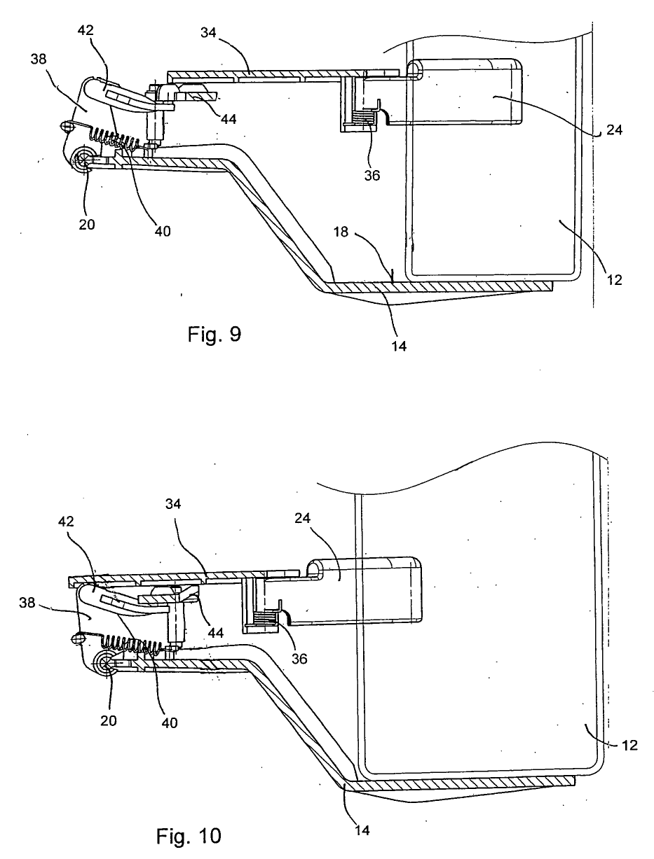

In the following the mechanism with which the cup holder 10 can adapt to different cup diameters is explained with reference to FIGS. 9 and 10.

With a pivotal movement of the base plate 14, a translatory movement of the bearing plate 34 and the holding part 24 connected thereto is made possible by the lever gear. It is however a requirement that the bearing plate 34 with the holding part 24 undergoes a larger translatory movement if there is a smaller cup diameter than with a large cup diameter because the holding part 24 must engage the cup 12 in order to hold it securely.

The actuation lever 38, which is connected to the base plate 14 by means of the spring 40, can remain behind the pivot movement of the base plate 14 with a given large cup diameter. If the holding part 24 is already resting against the cup diameter—i.e. need not therefore be moved any further—the spring 40 is stretched. The pin 46 of the transmission lever 44 is not moved further in the link 48 here, and so limits the translatory movement of the bearing plate 34.

With a smaller cup diameter, the pin 46 of the transmission lever 44 is moved by the actuation lever 38 and the coupling lever 42 further towards the cup 12 because no resistance opposes the translatory movement, so that even a small cup diameter can be clamped securely between the holding part 24 and the rounded section of the support 16.

FIGS. 16 to 34 show the cup holder 10 in a second embodiment. For the components which are already known, the same reference numbers are used, and in this respect, one should refer to the above explanations.

The base plate 14 can once again take the initial position (FIG. 16) and the holding position (FIG. 18).

The support surface 18 of the base plate 14 is graduated in form so that the base plate 14 is of compact design and fits into the housing 13 in the retracted position.

In the retracted position, the section 53 of the base plate 14 forms the part visible to a passenger in the centre console of the car.

In the area between the support surface 18 and the pressure spring 22, the base plate 14 has a side edge which serves as an actuation surface 60 because it has a particular geometric outer form, the function of which will be discussed below.

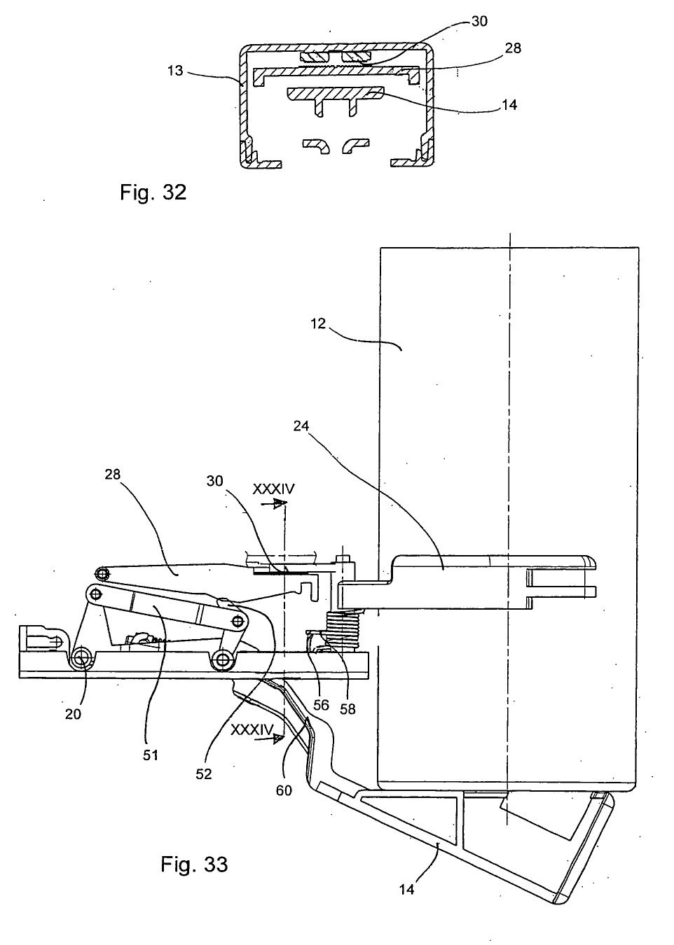

In this embodiment as well, the brake 26 consists of the brake shoe 28 and the brake surface 30 allocated thereto. The brake shoe 28 extends almost completely over the cross section of the support 16 (FIG. 32). The brake shoe 28 is attached to the support 16 by the attachment means 32. Both the brake shoe 28 and the brake surface 30 which is allocated to the holding part 24, have toothing, the toothing being arranged in a circular arc. The brake shoe 28 can be pressed against the brake surface 30 by means of the actuation lever 52, which is connected to the base plate 14 by means of the lever 51.

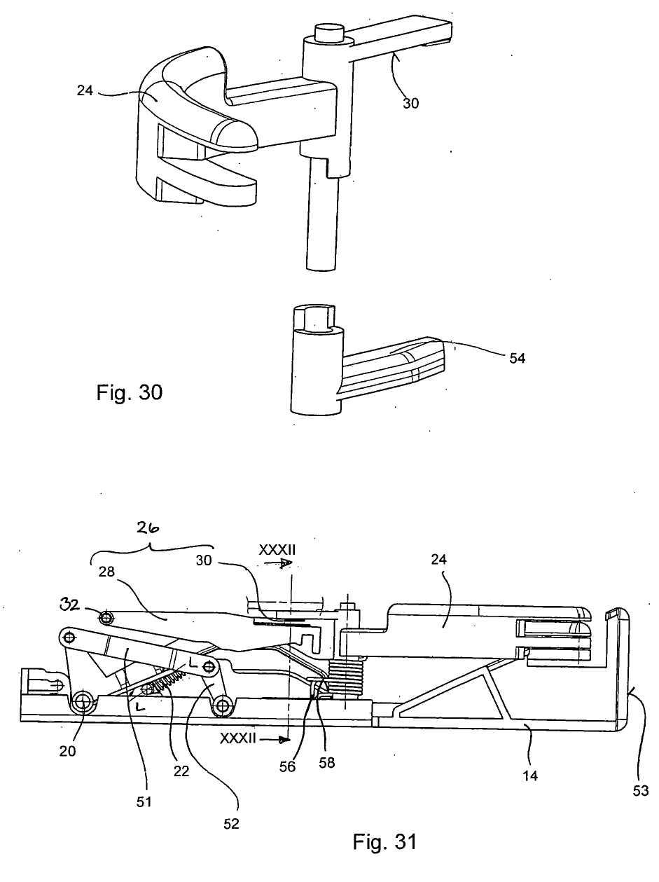

The cup holder 10 has two holding parts 24 positioned opposite one another, and which are essentially of the same design. FIG. 30 shows a holding part 24. The holding part 24 has a section which is curved in form and can encompass a cup 12. The curved section has a steeper curve in the middle, and therefore a smaller radius of curvature, whereas the curve becomes slighter towards the open end; the radius of curvature therefore increases. This makes it possible to clamp cups 12 of different diameters such that they are respectively held by the cup holder 10 at four points which are staggered by approximately 90°. This can be seen by comparing FIGS. 19 and 21, where a cup 12 with a small diameter (FIG. 19) and one with a large diameter (FIG. 21) are shown.

Furthermore, the holding part 24 has another section on the lower side of which the brake surface 30 is arranged. The holding part 24 located opposite this is of a corresponding design. Both of the holding parts 24 are mounted such that they can move rotatorily.

A lever 54 is connected to each holding part 24. Both levers 54 are of the same design. In their geometric form, the levers 54 are of such a design that they can be pressed outwards by the actuation surface 60 of the base plate 14.

The levers 54 are mounted pivotably on the support 16 and are connected to the holding parts 24 by a spring 56 each. The springs 56 make it possible here to compensate different cup diameters. The connection between the holding parts 24 and the levers 54 is chosen such that the rotation of the holding parts 24 can remain behind the rotation of the levers 54, and in this way, different cup diameters can be compensated (see in particular FIGS. 25 and 29).

Another spring 58 is arranged respectively between the levers 54 and the housing 13, and keeps the levers 54 pre-tensioned.

The cup holder 10 has the rectangular housing 13 in which the base plate 14, the support 16 and the holding parts 24 are movably attached.

In the following, the function of the cup holder 10 is explained.

The cup holder 10 is urged by the spring 50 into the extended position after a push on the externally visible section 53 of the base plate 14 (see first embodiment). The holding parts 24, which are subject to pre-tensioning of the springs 56, are urged outwards into a rest position when moved out of the housing 13. Owing to the connection with the holding parts 24, the levers 54 are moved such that they contact one another (FIG. 29). In the extended position, the base plate 14 is located above the levers 54. The base plate 14 is held in the initial position due to the snap mechanism of the pressure spring 22.

In the initial position, the base plate 14 does not actuate the lever 51, and hence, does not actuate the actuation lever 52 of the brake 26, so that the brake shoe 28 is not pressed against the brake surface 30 (FIG. 31).

When the base plate 14 is moved about the rotation axis A which is on the attachment means 20, the line of action L of the pressure spring 22 also changes here from one side of the pivot axis A of the base plate 14 to the other. When this happens, the pressure spring 22 is first of all compressed until a dead centre is reached. The pressure spring 22 then presses the base plate 14 downwards.

When positioning the cup 12, the base plate 14 is moved into the holding position. The actuation surface 60 of the base plate 14 here engages the levers 54 so that they are pushed apart (FIG. 25). The effect of the levers 54 being pushed apart is that the holding parts 24 encompass the cup 12, i.e. that they move rotatorily towards the cup 12. This movement is made possible by the springs 56 which provide a connection between the levers 54 and the holding parts 24. The springs 58 urge the levers 54 here against the actuation surface 60 so that there is a connection between the base plate 14 and the holding parts 24 (FIG. 24).

Because the base plate 14 is connected by means of the lever 51 to the actuation lever 52 and the latter engages the brake shoe 28, when the base plate 14 reaches the holding position, the actuation lever 52 is pressed against the brake shoe 28. The brake shoe 28 is pressed against the brake surface 30 and locks the holding part 24 (FIG. 33). The brake shoe 28 is pressed against the brake surface 30 by the actuation lever 52 when the base plate 14 is in the holding position. Even when the cup 12 is removed, the cup holder 10 remains in the holding position because the actuation lever 52 is in a stable position where it is positioned perpendicularly to the brake surface 30. Here, despite the pressure from above, the actuation lever 52 can securely lock the holding parts 24. The brake 26 is only released again when the cup holder 10 is pushed in so that the base plate 14 is pivoted upwards into the initial position.

By continuously pushing the section 53 of the base plate 14, the retracted position is restored so that the support 16 with the base plate 14 and the holding parts 24 are pushed back into the housing 13. The spring 50 is now pre-tensioned, and the cup holder 10 is locked in the retracted position by the push-push mechanism.

The cup holder 10 can adapt to different cup diameters. This is made possible by the respective connection between the levers 54 and the holding parts 24. By means of the springs 56, the rotation of the holding parts 24 can be kept behind the rotation of the levers 54. Because the levers 54 are directly coupled with the pivot movement of the base plate 14, the holding parts 24 can therefore remain behind the pivot movement of the base plate 14. Cups 12 with different cup diameters can thus be securely encompassed.

With a larger cup diameter, the holding parts 24 need not be adjusted so far rotatorily, whereas with a smaller cup diameter, the holding parts 24 undergo a greater adjustment.

The cup holder 10 can also have just one single rotatably adjustable holding part 24, or consist of a rotatably adjustable holding part 24 and a movable bearing plate 34.

The cup holder 10 can thus securely encompass a cup 12 independently of the given cup diameter.

1. A cup holder, in particular for a motor vehicle, comprising
a base plate (14),
a support (16) onto which said base plate (14) is attached such that it is adjustable between an initial position and a holding position for a cup (12), and
a holding part (24) which is connected to said base plate (14) such that, when said base plate (14) is brought from said initial position to said holding position, it is brought from an initial position to a holding position in which it reliably holds said cup (10) securely in said cup holder (12).

2. The cup holder according to claim 1, wherein a horizontal axis (A) is provided, said base plate (14) being pivotable about said horizontal axis (A).

3. The cup holder according to claim 1, wherein a snap mechanism is provided which either urges said base plate (14) into said initial position or said holding position.

4. The cup holder according to claim 3, wherein said snap mechanism has a pressure spring (22), said pressure spring (22) comprising a line of action (L) and said line of action (L) of said pressure spring (22) changing from one side of said pivot axis (A) of said base plate (14) to the other when a transition is made from said initial position to said holding position.

5. The cup holder according to claim 1, wherein a brake (26) is provided which locks said holding part (24) in said holding position.

6. The cup holder according to claim 5, wherein said brake (26) is formed by an adjustable brake shoe (28), which is attached to said support (16), and a brake surface (30), which is allocated to said holding part (24).

7. The cup holder according to claim 6, wherein an actuation lever (52) is provided which is connected to said base plate (14) and presses said brake shoe (28) against said brake surface (30) when said base plate (14) is in said holding position.

8. The cup holder according to claim 6, wherein at least one of said brake shoe (28) and said brake surface (30) are provided with toothing.

9. The cup holder according to claim 1, wherein said holding part (24) can be moved translatorily from said initial position to said holding position.

10. The cup holder according to claim 9, wherein a bearing plate (34) is provided and said holding part (24) is attached to said bearing plate (34) which is attached movably to said support (16).

11. The cup holder according to claim 10, wherein said holding part (24) is attached pivotably to said bearing plate (34) and a spring (36) is provided, said bearing plate (34) being urged by said spring (36) into a rest position.

12. The cup holder according to claim 10, wherein a lever gear is provided which converts said pivot movement of said base plate (14) into a translatory movement of said bearing plate (34) when a transition is made from said initial position to said holding position.

13. The cup holder according to claim 12, wherein a spring (40) is provided and said lever gear has an actuation lever (38) which is connected to said base plate (14) by means of said spring (40), so that said actuation lever (38) can remain behind said pivot movement of said base plate (14).

14. The cup holder according to claim 13, wherein a coupling lever (42) and a transmission lever (44) are provided and said actuation lever (38) is connected to said coupling lever (42) which in turn is connected to said transmission lever (44) which is attached pivotably to said support (16) and engages said bearing plate (34) for said holding part (24).

15. The cup holder according to claim 14, wherein a pin (46) and a link (48) are provided, said transmission lever (44) having said pin (46) which engages said link (48) in said bearing plate (34).

16. The cup holder according to claim 7, wherein said brake surface (30) is formed on said bearing plate (34).

17. The cup holder according to claim 1, wherein said holding part (24) is rotatably movable from said initial position to said holding position.

18. The cup holder according to claim 17, wherein said holding part (24) is mounted pivotably on said support (16).

19. The cup holder according to claim 17, wherein two holding parts (24) are provided, located opposite one another.

20. The cup holder according to claim 17, wherein a lever (54) and a spring (56) are provided, the lever (54) being mounted pivotably on said support (16) and being connected to said holding part (24) by means of said spring (56) so that said rotation of said holding part (24) can remain behind said rotation of said lever (54).

21. The cup holder according to claim 7, wherein said holding part (24) is provided with said brake surface (30).

22. The cup holder according to claim 20, wherein said base plate (14) has an actuation surface (60) which engages said lever (54) such that said latter is adjusted outwards when said base plate (14) is pivoted from said initial position into said holding position.

23. The cup holder according to claim 1, wherein a housing (13) is provided in which said support (16) is movably attached with said base plate (14) and said holding part (24), that a spring (50) is provided which urges said support (16) into an extended position, and that a push-push mechanism is provided which can both lock said support (16) in a retracted position, and release it.

24. The cup holder according to claim 23, wherein said spring (50) is a roller spring.
